(19) United States
(12) Patent Application Publication
(10) Pub. No.: US 2007/0007886 A1
(43) Pub. Date: Jan. 11, 2007

(54) Plasma display panel

(76) Inventors: Min Hur, Youngin-si (KR); Joon Yeon Kim, Youngin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/448,642

(22) Filed: Jun. 7, 2006

(30) Foreign Application Priority Data
Jun. 13, 2005 (KR) 10-2005-0050244

(51) Int. Cl. H01J 1/62

(52) U.S. Cl. 313/505

(57) ABSTRACT

A plasma display panel having sustain and scan electrodes of different widest is disclosed. Embodiments of the plasma display panel allow scan electrodes performing reset discharge, address discharge, and sustain discharge to have a width or a thickness greater than that of sustain electrodes in order to relatively reduce impedance of the scan electrodes, thereby applying equal driving pulses to the scan and sustain electrodes during the sustain discharge period, resulting in improvement of the luminous efficiency of the plasma display panel.

### CROSS-REFERENCE TO RELATED APPLICATIONS

This application claims the benefit of Korean Patent Application No. 10-2005-0050244, filed on Jun. 13, 2005, in the Korean Intellectual Property Office, the disclosure of which is incorporated herein in its entirety by reference.

### BACKGROUND OF THE INVENTION

1. Field of the Invention

Embodiments of the present invention relate to a plasma display panel, and more particularly to a plasma display panel, which allows scan electrodes performing reset discharge, address discharge, and sustain discharge to have a width or a thickness greater than that of sustain electrodes in order to relatively reduce impedance of the scan electrodes, thereby applying equal driving pulses to both the scan and sustain electrodes during the sustain discharge period, resulting in the improvement of the luminous efficiency of the plasma display panel.

2. Description of the Related Technology

As generally known in the art, a plasma display panel refers to a panel used for a plasma display apparatus which is a flat display device. In the plasma display panel, plasma is obtained by performing gas discharge in a discharge gas injected in a discharge space between two opposed substrates. The plasma display panel displays an image by light radiated from fluorescent substances excited by ultraviolet rays created by the plasma. Such a plasma display panel can be classified into an alternating current type plasma display panel or a direct current type plasma display panel, based on its structure and driving principle. Also, a plasma display panel can be classified into a surface discharge type plasma display panel or an opposing discharge type plasma display panel. Recently, the opposing discharge type plasma display panel has been widely researched in order to supply a high definition plasma display panel.

The general surface discharge type plasma display panel includes a front substrate, a back substrate opposite to the front substrate, and electrodes for discharging electricity.

The front substrate is generally a glass substrate formed with soda glass to have the thickness of 2.8 mm, so that visible light generated from the fluorescent substance layer can be transmitted through the front substrate. Further, the front substrate has a pair of X and Y electrodes which are arranged on a lower surface of the front substrate to generate sustain discharge. Such electrodes include transparent electrodes formed with Indium Tin Oxide (ITO). A bus electrode is formed below the transparent electrodes. Such a bus electrode has a width narrower than that of the transparent electrodes, and plays a role of compensating for the line resistance of the transparent electrodes. The front substrate has a dielectric layer formed on the lower surface thereof, in order to bury the transparent electrodes and to avoid an exposure of the transparent electrodes, and has a protective layer for protecting the dielectric layer.

The back substrate has address electrodes which are arranged on an upper surface thereof to intersect with the transparent electrodes of the front substrate. Further, the back substrate has a dielectric layer formed on the upper surface thereof in order to avoid exposure of the address electrodes. Barriers are formed on the upper surface of the back substrate in order to hold a discharge distance and to prevent electric and optical crosstalk between discharge cells. These barriers define the discharge cells, which are formed respectively between the front and back substrates to generate discharge, and which are minimum elements of pixels displaying images on the plasma display panel. Red, green, and blue fluorescent substances are coated on both side surfaces of each barrier defining the discharge cells and on an upper surface of the dielectric layer of the back substrate on which the barriers are not formed, so as to form a unit pixel.

However, a tri-polar surface discharge type plasma display panel has a large distance between the scan electrode and the address electrode, so as to require a relatively high discharge voltage. The plasma display panel starts the discharge in a region, i.e. at the center of the discharge cell in which the distance between the two electrodes is shortest. Then, the discharge is diffused toward the edge of the electrodes. The reason for this is because discharge starting voltage is low in the center of the discharge cell. When the discharge starts, space charge is formed so that the discharge is held under a voltage level that is lower than the discharge starting voltage. Furthermore, the voltage is gradually lowered between the two electrodes as time passes. After the discharge starts, ions and electrons accumulate at the center of the discharge cells, rendering a low intensity of the electric field and the discharge disappears from the center of the discharge cells. That is, since the voltage is gradually lowered between the two electrodes as time passes, an intensive discharge occurs in the center region of the discharge cell (structure in low luminous efficiency), while a weak discharge occurs at the edge region of the discharge cell (structure in high luminous efficiency). The tri-polar surface discharge type plasma display panel has a low ratio of input energy which is used for heating electrons and which depends on this same principle, thereby having low luminous efficiency.

Recently, the opposing discharge type plasma display panel has been developed in order to improve a disadvantage of the tri-polar discharge type plasma display panel. This opposing discharge type plasma display panel has a scan electrode and a sustain electrode formed between front and back substrates so as to be opposite to each other, and an address electrode formed on a lower surface of the front substrate or on an upper surface of the back substrate so as to intersect the scan and sustain electrodes. Thus, in comparison with the surface discharge type plasma display panel, the opposing discharge type plasma display panel requires a small area to form the scan and sustain electrodes, so as to supply highly accurate and definite images. Further, since the scan electrode and the sustain electrode are opposite to each other in order to increase opposing area and discharge space, the discharge efficiency of the opposing discharge type plasma display panel can be improved in comparison with that of the surface discharge type plasma display panel.

In the opposing discharge type plasma display panel, however, the scan electrode performs all of the reset discharge, scan discharge and sustain discharge in a discharge mode in a way which is different from that of the sustain electrode. Therefore, a driving board for driving the scan electrode includes pulse generators which respectively generates reset pulses, scan pulses, and sustain pulses, a circuit portion for applying the sustain pulses, MOSFETs, a switch device for driving a scan driver IC, and the like. On the other hand, a driving board for driving the sustain electrode includes only a pulse generator for generating a sustain pulse, so that it can be made from a small number of elements. The scan electrode driving board has an impedance greater than that of the sustain electrode driving board. This impedance difference between the driving boards is caused by the difference of the pulses applied to the scan electrode and the sustain electrode, respectively. That is, when discharge voltages are applied to the scan electrode and the sustain electrode, the pulses of the applied discharge voltages are partially distorted due to the impedances of each driving board and the electrodes. Specifically, since the scan electrode driving board has relatively high impedance, the pulse of the scan electrode can be relatively and significantly distorted. When the voltage pulse applied to the scan electrode is relatively and significantly distorted so as to differ from the voltage pulse applied to the sustain electrode, it causes the difference in brightness of the light generated during a sustain discharge period. This phenomenon makes it difficult to finely control the brightness of the plasma display panel, in which the brightness of the panel can be determined by the number of the sustain pulses. In the case where the electrodes are arranged in an alternative manner, i.e., the order of sustain electrode-scan electrode-sustain electrode-scan electrode, in the opposing discharge type plasma display panel, this phenomenon causes stripes to be generated on a screen of the panel.

The above-mentioned problems can be caused in the opposing discharge type plasma display panel as well as in the surface discharge type plasma display panel.

### SUMMARY OF THE CERTAIN INVENTIVE ASPECTS

Accordingly, embodiments of the present invention have been made to solve one or more of the above-mentioned problems occurring in the prior art, and embodiments are directed to provide a plasma display panel which allows scan electrodes performing reset discharge, address discharge, and sustain discharge to have a width or a thickness greater than that of sustain electrodes in order to relatively reduce impedance of the scan electrodes, thereby applying equal driving pulses to both the scan and sustain electrodes during the sustain discharge period, resulting in the improvement of the luminous efficiency of the plasma display panel.

In order to accomplish this, one aspect of the invention is a plasma display panel comprising: a first substrate and a second substrate facing the first substrate; a back barrier layer including first barriers arranged adjacent to an upper surface of the first substrate in parallel with another barrier in one direction, and second barriers arranged in a direction which intersects the first barriers, the back barrier layer defining a plurality of back discharge spaces; fluorescent substance layers formed in the back discharge spaces; first and second electrodes formed on an upper portion of the first barriers in such a way that they are parallel with the first barriers, the first and second electrodes being alternatively arranged around the back discharge spaces; and a plurality of address electrodes which intersect the first and second electrodes and are substantially parallel with another address electrode on the first substrate, wherein the first electrodes have a width greater than that of the second electrodes.

In certain embodiments, the second substrate further includes front barrier layers which are formed on a lower surface of the second substrate in order to generally face the back barrier layer and define a plurality of front discharge spaces. The back discharge spaces have reflection type fluorescent substance layers formed in the back discharge spaces, while the front discharge spaces have transmission type fluorescent substance layers formed in the front discharge spaces.

Further, in other embodiments, the first and second electrodes can be metal. The first electrodes are formed as scan electrodes, and the second electrodes are formed as sustain electrodes. In addition, the first and second electrodes have a first dielectric layer and a second dielectric layer formed on both sidewalls of the first and second electrodes, respectively. The first dielectric layer and the second dielectric layer have MgO protective layers formed on both sidewalls of the first and second dielectric layers.

The back barrier layers in certain embodiments further comprise auxiliary barriers formed at a desired height on an upper surface of the second barriers in a direction substantially parallel with the second barriers. Preferably, the auxiliary barriers have the same height as that of the dielectric substance layer.

Furthermore, in various embodiments, the address electrodes are generally arranged in a central region of a lower portion of the back discharge spaces. The first substrate has a third dielectric layer covering the address electrodes.

### BRIEF DESCRIPTION OF THE DRAWINGS

The above and other features and advantages of the claimed embodiments will be more apparent from the following detailed description taken in conjunction with the accompanying drawings.

FIG. 1 is a partial exploded schematic perspective view showing a plasma display panel according to an embodiment; and

FIG. 2 is a sectional view showing the plasma display panel according to one embodiment, taken along a line A-A in FIG. 1.

### DETAILED DESCRIPTION OF THE PREFERRED EMBODIMENTS

Hereinafter, embodiments will be described with reference to the accompanying drawings.

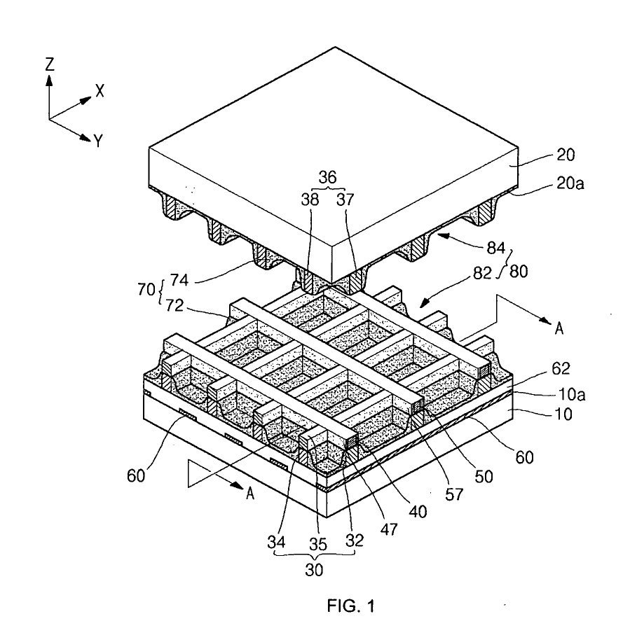

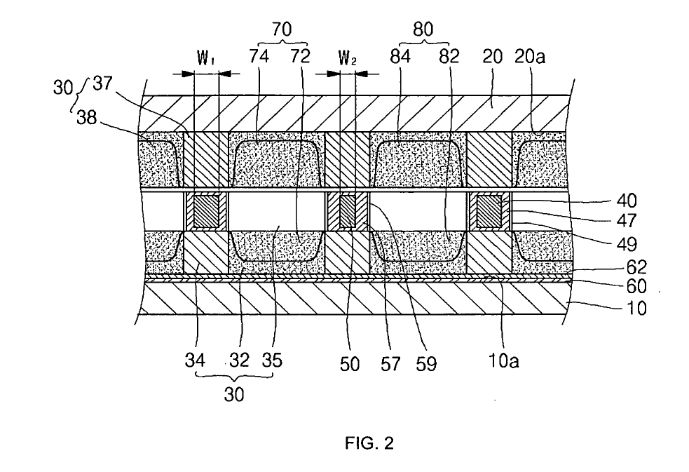

FIG. 1 is a partial exploded schematic perspective view showing a plasma display panel according to an embodiment, and FIG. 2 is a sectional view showing the plasma display panel according to one embodiment, taken along a line A-A in FIG. 1.

Referring to FIGS. 1 and 2, the plasma display panel according to one embodiment includes a first substrate 10 (hereinafter, referred to as a back substrate), a second substrate 20 (hereinafter, referred to as a front substrate), a back barrier layer 30, first electrodes 40, second electrodes 50, address electrodes 60, and fluorescent substance layers 70. The front substrate 20 has a front barrier layer 36 provided to an upper surface thereof. The first electrodes 40 and the second electrodes 50 form scan electrodes which perform address discharge and display discharge as well as sustain electrodes which perform the display discharge along with the scan electrodes. Therefore, the first electrodes 40 are referred to as the scan electrodes, and the second electrodes 50 are referred to as the sustain electrodes. Of course, it is understood that the first electrodes 40 may form the sustain electrodes and the second electrodes 50 may be the scan electrodes. The first electrodes 40 have a width greater than that of the second electrodes 50, while having their total impedance relatively reduced.

The back substrate 10 faces the front substrate 20 at a predetermined distance. A plurality of discharge spaces 80 are defined by the back barrier layer 30 between the back substrate 10 and the front substrate 20. Each of the discharge spaces 80 is formed as a discharge cell, including the back discharge space 82 as defined by the back barrier layer 30 and a space defined by the first and second electrodes 40 and 50. Further, in the case of forming the front barrier layer 36, the discharge space 80 includes a front discharge space 84 defined by the front barrier layer 36. The discharge space 80 has a fluorescent substance layer 70 which is coated onto a predetermined region thereof and absorbs vacuum ultraviolet rays so as to emit visual-rays, while being filled with a discharge gas which creates the vacuum ultraviolet rays by plasma discharge. The fluorescent substance layer 70 includes a reflection type fluorescent substance layer 72 formed on the back substrate and a transmission type fluorescent substance layer 74 formed on the front substrate.

The back substrate 10 can be made of material with a predetermined thickness such as glass, which forms a plasma display panel along with the front substrate 20. The back substrate 10 has the address electrodes 60 which are arranged in one direction on an upper surface 10a of the back substrate 10 facing the front substrate 20, and a second dielectric layer 62 coated on the upper surface 10a of the back substrate 10 to cover the address electrodes 60. Further, the back barrier layer 30 is formed on the second dielectric layer 62. A surface of structural elements facing the front substrate 20 (in a +Z direction of FIG. 1) is referred to as an upper surface, while a surface of structural elements facing the back substrate 10 (in a −Z direction of FIG. 1) is referred to as a lower surface.

The front substrate 20 is formed from a transparent material, such as soda glass, and faces the back substrate 10. Further, the front substrate 20 has the front barrier layer 36 at a lower surface thereof facing the back substrate 10.

The back barrier layer 30 includes first barriers 32 formed in one direction (y direction in FIG. 1) in parallel with each other, and second barriers 34 formed in a direction that intersects the first barriers 32 (x direction in FIG. 1). Furthermore, the back barrier layer 30 may have auxiliary barriers 35 formed on the second barriers 34. Thus, the back barrier layer 30 can define the back discharge space 82 which is a part of the plural discharge spaces 80 which are capable of creating discharge between the back substrate 10 and the front substrate 20. The back barrier layer 30 may be formed from glass materials including elements such as Pb, B, Si, Al, O, etc.

The auxiliary barriers 35 are formed at a desired height on the second barriers 34 so as to be parallel with the second barriers 34, preferably they may be formed at the identical height of the first and second dielectric layers 47 and 57. Furthermore, the auxiliary barriers 35 intersect the first and second electrodes 40 and 50 and are connected to the first and second dielectric layers 47 and 57 which are formed outside the first and second electrodes 40 and 50. Therefore, the auxiliary barriers 35 define the discharge spaces 80 along with the back barrier layer 30, the first dielectric layer 57, and the second dielectric layer 57, depending on their height, and prevent cross talk from occurring between neighboring discharge spaces. The auxiliary barriers 35 may be formed with the same material as that of the back barrier layer 30. Further, the auxiliary barriers 35 may be made of the same dielectric material as the first and second dielectric layers 47 and 57.

The front barrier layer 36 is formed to face the back barrier layer 30 formed on the back substrate 10. That is, the front barrier layer 36 includes third barriers 37 corresponding to the first barriers 32 of the back barrier layer 30 and fourth barriers 38 corresponding to the second barriers 34 of the back barrier layer 30. Therefore, the front barrier layer 36 has the front discharge spaces 84 formed on a lower portion thereof, like the back barrier layer 30. The discharge spaces 80 are defined by the back discharge spaces 82 and the front discharge space 84. The front barrier layer 36 can be formed, for example, from a glass material. However, the front barrier layer 36 may also be preferably made of the same material as that of the back barrier layer 30.

The first and the second electrodes 40 and 50 are arranged on the first barriers 32 of the back barrier layer 30 to be parallel with the first barriers 32. Furthermore, the first and second electrodes 40 and 50 are alternately arranged beside the discharge spaces 80. Each of the first and second electrodes 40 and 50 has surfaces defining neighboring discharge spaces 80. Preferably, the first and second electrodes 40 and 50 have a width smaller than their height when cut in a longitudinal direction. The width means a length in a horizontal direction of the first and second electrodes 40 and 50, while the height means a length in a vertical direction of the first and second electrodes 40 and 50. Therefore, the first and second electrodes 40 and 50 perform while facing discharge in a wider area, so as to create more intensive ultraviolet rays, which in turn collide against the fluorescent substance layer 70 of the discharge spaces 80 to increase the intensity of the light. Furthermore, the first electrodes 40 can perform address discharge, along with the address electrodes 60, in a wider area as described below, thereby causing the address discharge to be more efficiently performed.

As described above, the first electrodes 40 have a width W1 (See FIG. 2) greater than the width W2 of the second electrodes 50. As described above, since the electrodes used as the scan electrodes generally perform the reset discharge, the scan discharge, and the sustain discharge during a discharge procedure of the plasma display panel, switches for driving a necessary circuit portion, MOSFETs, and a driver are connected to a driving board (not shown) for the first electrodes. Thus, the scan electrodes have a total increasing impedance because of the impedance of the driving board, which has an impedance larger than that of the sustain electrodes. Therefore, the first electrodes 40 have a relative width greater than that of the second electrodes 50 (see FIG. 2) used as the sustain electrodes. When the second electrodes 50 are formed to have identical height, the first electrodes 40, relatively, have wider sectional area and greater whole volume in proportion with the second electrodes 50, so as to have reduced impedance. Thus, the first electrodes 40 have reduced impedance and offset the increase of the impedance from the driving board, so as to have impedance similar to the impedance of the second electrodes 50. As a result, it is possible to reduce the disparity that lies between the pulse of discharge voltage applied to the second electrodes 50 and the impedance of the first electrode. The first electrodes 40 are formed to have a predetermined width in view of the impedance of the second electrodes 50. The impedance of the first and second electrodes 40 and 50 can be measured using a suitable measuring apparatus. The widths of the first and second electrodes 40 and 50 can be determined based on such a measured result.

The first and second electrodes 40 and 50 are arranged on the first barriers 32 in such a way that the first and second electrodes 40 and 50 barely cover the whole surface of the discharge spaces, thereby not requiring transparency. The first and second electrodes 40 and 50 may be made from a general conductive metal which differs from the surface discharge type transparent electrodes. The first and second electrodes 40 and 50 are preferably formed from a metal which has excellent conductivity and a low resistance, such as, for example, Ag, Al, and Cu, which have various advantages in that the response speed depends on the discharge, in that signals are not distorted, and power consumption for the sustain discharge can be reduced. It is understood that there are other suitable materials for the first and second electrodes 40 and 50, and various metals which have excellent conductivity and a lower resistance can be used as the material for the first and second electrodes 40 and 50.

The first and second electrodes 40 and 50 have the first and second dielectric layers 47 and 57 which are respective insulation layers on an exterior surface thereof. The first and second dielectric layers 47 and 57 are formed with dielectric material. That is, the first and second dielectric layers 47 and 57 are formed from glass material including elements such as, for example, Pb, B, Si, Al, and O, and are preferably formed from dielectric material including filler such as ZrO₂, TiO₂, and Al₂O₃, and pigment such as Cr, Cu, Co, and Fe. However, there is no limitation to the component of the back barrier layer 30. The back barrier layer 30 may be formed from various dielectric materials. The back barrier layer 30 enables the electrodes arranged in the back barrier layer 30 to easily discharge electricity, and prevents the electrodes from being damaged due to collisions of charged particles which are accelerated during the discharge. It is understood that there is no limitation to the material of the first and second dielectric layers 47 and 57, and the first and second dielectric layers 47 and 57 can be formed from various dielectric materials.

Furthermore, the first and second dielectric layers 47 and 57 have protective layers 49 and 59 formed on an exterior surface thereof, preferably MgO protective layers including MgO. The MgO protective layers 49 and 59 (see FIG. 2) prevent the first and second dielectric layers 47 and 57 from being damaged during the discharge.

The address electrodes 60 intersect the first and second electrodes 40 and 50 with insulation, which is arranged in parallel to the first substrate 10, preferably passing through a center of a lower portion of the discharge spaces 80. Further, the address electrodes 60 are arranged in parallel on the upper surface 10a of the back substrate 10 at a distance from each other corresponding to the distance between the discharge spaces 80. Further, the address electrodes 60 are covered with third dielectric layer 62. That is, the third dielectric layer 62 is entirely formed on the back substrate 10 to cover the address electrodes 60. The third dielectric layer 62 allows the address electrodes 60 to perform discharge and prevents the address electrodes 60 from being damaged due to collisions of the discharged particles which are accelerated during the discharge.

The fluorescent substance layer 70 includes a first fluorescent substance layer 72 formed in the interior of the back discharge spaces 82 of the discharge spaces 80 and a second fluorescent substance layer 74 formed in the interior of the front discharge spaces 84 of the discharge spaces 80. However, it is understood that the fluorescent substance layer 70 may include the first fluorescent substance layer 72 formed in the interior of the back discharge spaces 82. The first fluorescent substance layer 72 is preferably coated on the inner side surfaces of the back barrier layer 30 and the upper surface of the back substrate 10 in the back discharge spaces 80. The reflection type fluorescent substance layer may be used instead of the first fluorescent substance layer 72. Thus, the first fluorescent substance layer 72 absorbs vacuum ultraviolet rays, so as to create visual rays, and reflects the visual rays toward the front substrate 20. The second fluorescent substance layer 74 is coated on the inner side surfaces of the front barrier layer 36 and on the lower surface of the front substrate 20. Preferably, the transmission type fluorescent may be used instead of the second fluorescent substance layer 74. Such a second fluorescent substance layer can absorb vacuum ultraviolet rays and transmits visual rays toward the front substrate 20. Preferably, the fluorescent substance layer 70 is formed such that the transmission type second fluorescent substance layer 74 has a thickness smaller than that of the reflection type first fluorescent substance layer 72, which is in order to increase the transmittance of the visual rays transmitted through the second fluorescent layer 74 toward the front substrate 20. That is, the transmittance of the visual rays in the second fluorescent substance layer 74 is generally proportional to the thickness of the fluorescent substance layer. Therefore, the second fluorescent substance layer 74 is formed to have a suitable thickness in view of the radiation efficiency of the discharge cells. However, since the first fluorescent substance layer 72 reflects visual rays, the first fluorescent substance layer 72 is formed to have a sufficient thickness in view of the radiation efficiency of the discharge cells.

The fluorescent substance layer 70 has components to absorb ultraviolet radiation and to create light such that: a red fluorescent substance layer formed in the discharge cell emitting red light includes a fluorescent substance such as Y(V,P)O₄:Eu: a green fluorescent substance layer formed in the discharge cell emitting green light includes a fluorescent substance such as Zn₂SiO₄:Mn; and a blue fluorescent substance layer formed in the discharge cell emitting blue light includes a fluorescent substance such as BAM:Eu. The fluorescent substance layer 70 is divided into the red fluorescent substance layer, the green fluorescent substance layer, and the blue fluorescent substance layer, which are formed in neighboring discharge spaces 80, respectively. The neighboring discharge spaces 80, in which the red fluorescent substance layer, the green fluorescent substance layer, and the blue fluorescent substance layer are respectively formed, are operationally coordinated with one another to achieve a unit pixel with the desired color. Furthermore, the second fluorescent substance layer 74 is formed on the front barrier layer 36 and the front substrate 20 such that only any one of the red, green, and blue fluorescent substance layers is formed on the second barrier. Thus, the first fluorescent substance layer is formed on the back barrier layer 30 to correspond to the color of the second fluorescent substance layer 74.

The discharge spaces 80 are defined by the back discharge spaces 82, the first electrodes 40 which are coated on the first dielectric layer 47, and the second electrodes 50 which are coated on the second dielectric layer 57, respectively. Further, in the case where the front barrier layer 36 is formed on a lower surface of the front substrate 20, the front discharge spaces 84 also define the discharge spaces 80, respectively. Furthermore, in the case where the auxiliary barriers 35 are formed on the second barriers 34, the auxiliary barriers 35 can define the discharge spaces. The discharge spaces 80 are filled with discharge gases, for example, mixed gases including Xe, Ne, etc., so that the plasma discharge occurs in the discharge spaces 80. Furthermore, the discharge spaces 80 have a certain region in which the fluorescent substance layer 70 absorbs the ultraviolet radiation and emits light, as described above. The discharge spaces 80 respectively have a different width or length, depending on their radiation efficiencies. In addition, the discharge spaces 80 have the electrodes arranged on the lower portion thereof in order to perform the address discharge and the sustain discharge, while having the fluorescent substance layer formed thereon. Thus, the radiation efficiency of the discharge spaces 80 is improved.

Even though the opposite discharge type of plasma display panel has been descried above, it is understood that the present embodiments can also be applied to the surface discharge type of plasma display panel. That is, in the surface discharge type of plasma display panel, the scan electrode and the sustain electrode, which generate a display discharge, include a transparent electrode and a bus electrode which respectively have a desired width and height. The bus electrode which forms the scan electrode may be formed to have a width greater than that of the bus electrode forming the sustain electrode. Further, the transparent electrode forming the scan electrode may be formed to have a width greater than the transparent electrode forming the sustain electrode.

According to the plasma display panel of the present embodiments, since the scan electrode has a width greater than the sustain electrode, the impedance of the scan electrode is reduced, so as to prevent the waveform of the voltage applied to the scan electrode during the sustain discharge from being distorted. Further, in the plasma display panel of the present embodiments, the voltage applied to the scan electrode during the sustain discharge has nearly the same waveform as that of the discharge voltage applied to the sustain electrode, thereby improving the discharge efficiency of the plasma display panel.

Although various embodiments have been described for illustrative purposes, those skilled in the art will appreciate that various modifications, additions, and substitutions are possible, without departing from the scope and spirit of the embodiments as disclosed in the accompanying claims.

What is claimed is:

1. A plasma display panel comprising:
a first substrate and a second substrate facing the first substrate;
a back barrier layer including first barriers arranged adjacent to an upper surface of the first substrate substantially parallel to another barrier, and second barriers arranged in a direction which intersects the first barriers, the back barrier layer defining a plurality of back discharge spaces;
fluorescent substance layers formed on the back discharge spaces;
first and second electrodes formed on an upper portion of the first barriers to be substantially parallel with the first barriers, the first and second electrodes being arranged around the back discharge spaces; and
a plurality of address electrodes intersecting the first and second electrodes and arranged substantially parallel to another address electrode on the first substrate,
wherein the first electrodes are wider than the second electrodes.

2. The plasma display panel of claim 1, wherein the second substrate further includes front barrier layers formed on a lower surface of the second substrate so as to generally face the back barrier layer and defining a plurality of front discharge spaces.

3. The plasma display panel of claim 2, wherein the back discharge spaces have reflection type fluorescent substance layers formed on the back discharge spaces, and wherein the front discharge spaces have transmission type fluorescent substance layers formed on the front discharge spaces.

4. The plasma display panel of claim 1, wherein the first and second electrodes are made of metal.

5. The plasma display panel of claim 1, wherein the first electrodes form scan electrodes, and the second electrodes form sustain electrodes.

6. The plasma display panel of claim 1, wherein the first and second electrodes have a first dielectric layer and a second dielectric layer formed on both sidewalls of the first and second electrodes, respectively.

7. The plasma display panel of claim 6, wherein the first dielectric layer and the second dielectric layer have MgO protective layers formed on both sidewalls of the first and second dielectric layers.

8. The plasma display panel of claim 1, wherein the back barrier layers further comprise auxiliary barriers formed at a desired height on an upper surface of the second barriers in a direction substantially parallel with the second barriers.

9. The plasma display panel of claim 8, wherein the auxiliary barriers have the same height as that of the dielectric substance layer.

10. The plasma display panel of claim 1, wherein the address electrodes are generally arranged in a central region of a lower portion of the back discharge spaces.

11. The plasma display panel of claim 1, wherein the first substrate has a third dielectric layer covering the address electrodes.

12. A plasma display panel, comprising:
a plurality of discharge cells forming a matrix of pixels;
a plurality of address electrodes formed to be substantially parallel to one another and crossing the discharge cells in a first direction; and
a plurality of display electrodes substantially parallel to one another and crossing the discharge cells in a second direction which is substantially perpendicular to the first direction;
wherein alternating display electrodes have a different width than the remaining display electrodes.

13. The plasma display panel of claim 12, wherein the display electrodes are formed in pairs of sustain and scan electrodes with a given pair of electrodes allocated to a row of discharge cells in the matrix.

14. The plasma display panel of claim 12, wherein the scan electrodes are wider than the sustain electrodes.

15. The plasma display panel of claim 12, further comprising fluorescent material coated on the discharge cells.

16. The plasma display panel of claim 12, further comprising front and rear substrates covering the matrix and electrodes.

17. The plasma display panel of claim 12, further comprising a scan electrode driving board and a sustain electrode driving board.

18. The plasma display panel of claim 17, wherein the scan electrode driving board has a higher impedance than the sustain electrode driving board.
